(19) United States
(12) Patent Application Publication
(10) Pub. No.: US 2013/0110365 A1
(43) Pub. Date: May 2, 2013

(54) SHIFT-BY-WIRE SYSTEM FOR AUTOMATIC TRANSMISSION OF VEHICLE

(71) Applicant: Denso Corporation, Kariya-city (JP)

(72) Inventors: Kiyoshi Kimura, Kariya-city (JP); Jun Yamada, Nagoya-city (JP)

(73) Assignee: DENSO CORPORATION, Kariya-city (JP)

(21) Appl. No.: 13/655,693

(22) Filed: Oct. 19, 2012

(30) Foreign Application Priority Data
Oct. 28, 2011 (JP) 2011-237057

(51) Int. Cl. F16H 61/00

(52) U.S. Cl. 701/65; 701/51

(57) ABSTRACT

When an electronic control unit senses an abnormality of an encoder, the control unit rotates a rotor of an electronic motor unit through execution of an open-loop drive control operation in presence of an output of a signal from a range selector to shift a shift range of an automatic transmission to a target range and sets a range shifting operation prohibiting period after the shifting of the shift range of the automatic transmission to the target range to prohibit a new range shifting operation of the automatic transmission throughout the range shifting operation prohibiting period.

### CROSS REFERENCE TO RELATED APPLICATION

This application is based on and incorporates herein by reference Japanese Patent Application No. 2011-237057 filed on Oct. 28, 2011.

### TECHNICAL FIELD

The present disclosure relates to a shift-by-wire system for an automatic transmission of a vehicle.

### BACKGROUND

In the field of the vehicle control technology, there is often used a by-wire system. The by-wire system electrically controls an actuator, which changes an operational state of a vehicle, through a by-wire control circuit in response to a command of a driver (user) of the vehicle. For example, a shift-by-wire system, which shifts a shift range of an automatic transmission of the vehicle in response to a command of the driver of the vehicle, is known. In the shift-by-wire system, the shift range is shifted by, for example, rotating an electric actuator to drive a range shift mechanism of the automatic transmission. The range shift mechanism includes a detent plate and a detent spring. The detent plate is rotated by an actuator. The detent spring includes a limiting portion, which is adapted to be fitted into a corresponding one of recesses formed in the detent plate to limit the rotation of the detent plate and thereby to fix the shift range of the automatic transmission. The actuator includes an electric motor unit and a speed reducing unit. The motor unit is rotatable at a high speed. The speed reducing unit reduces the rotational speed of the motor unit and outputs the rotation of the reduced rotational speed. In a case where a brushless motor, such as a switched reluctance (SR) motor, is used in the motor unit, an incremental encoder (also referred to as an increment type encoder) is typically provided in the actuator. The incremental encoder outputs a pulse signal, which corresponds to an amount of change in the rotational angle of the electric motor unit. A rotational state of the motor unit is sensed based on the pulse signal outputted from the encoder, and the sensed state of the motor unit is used in a feedback control operation of the motor unit. In this way, the rotation of the motor unit can be appropriately controlled.

JP3849930B2 (US2004/0008002A1) discloses such a shift-by-wire system. Here, it should be noted that the contents of US2004/0008002A1 are entirely incorporated herein as reference. In this shift-by-wire system, normally, a feedback drive control operation is executed. In the feedback drive control operation, the electric motor unit is driven to rotate while a rotational state of the motor unit, which is sensed with a pulse signal from the encoder, is fed back to control the rotation of the motor unit. In contrast, when the encoder is in an abnormal state, the feedback of the rotational state of the motor unit is not performed, and the motor unit is driven through an open loop drive control operation, which drives the motor unit without using the feedback of the rotational state of the motor unit. In this shift-by-wire system, the rotation of the detent plate is limited by the resilient detent spring. Therefore, immediately after the shifting of the shift range of the automatic transmission to the target range through the rotation of the detent plate by the motor unit, the detent plate swings in the rotational direction for a while. A swing time period of the detent plate (i.e., a time period from a time point of starting the swing motion of the detent plate to a time point of stopping the swing motion of the detent plate immediately after the shifting of the shift range to the target range) may vary depending on, for example, component size tolerances of the range shift mechanism, the control accuracy of the motor unit and the environmental conditions (e.g., the environmental temperature condition).

At the shift-by-wire system of JP3849930B2 (US2004/0008002A1), in the case where the motor unit is rotated through the open-loop drive control operation upon occurrence of the abnormality of the encoder, it is possible to enter a new shifting command for shifting the shift range of the automatic transmission to another range even after the shifting of the shift range to the target range. Therefore, the new shifting command for shifting the shift range of the automatic transmission may possibly be entered even though the detent plate still swings. In the state where the detent plate swings, when the shifting command is entered, the rotation of the motor unit may possibly be started while the limiting portion of the detent spring is deviated from the center of the corresponding recess of the detent plate. For example, in the case where the garage shift (e.g., the park or neutral to drive shift) is executed to change the shift range frequently, when the rotation of the motor unit discussed above is repeated within a short period of time, a positional deviation between each corresponding recess and the limiting portion may be progressively increased. Therefore, there will possibly be a fatal mode, at which the shift range is shifted to a different unintended range that is different from the target range.

### SUMMARY

The present disclosure is made in view of the above disadvantage.

According to the present embodiment, there is provided a shift-by-wire system for an automatic transmission of a vehicle. The shift-by-wire system includes an electric motor unit, a speed reducing unit, an encoder, a detent plate, a detent spring and a controller. The electric motor unit includes a stator and a rotor. The rotor is rotatable relative to the stator. The speed reducing unit includes an output shaft. The speed reducing unit reduces a rotational speed of rotation transmitted from the rotor and outputs the rotation of the reduced rotational speed through the output shaft. The encoder outputs a pulse signal in response to the rotation of the rotor. The detent plate includes a plurality of recesses and is connected to the output shaft of the speed reducing unit. The detent plate is rotatable by a rotational drive force, which is transmitted from the electric motor unit through the output shaft of the speed reducing unit. The detent spring includes a limiting portion. When the limiting portion is fitted into one of the plurality of recesses, the rotation of the detent plate is limited to fix a shift range of the automatic transmission. The controller determines a target range of the automatic transmission among a plurality of ranges based on a signal outputted from a shift range selecting device upon manipulation of the shift range selecting device by a driver of the vehicle and shifts the shift range of the automatic transmission to the target range by rotating the rotor through execution of one of a feedback drive control operation and an open-loop drive control operation of the electric motor unit. When the controller executes the feedback drive control operation of the electric motor unit, the controller senses a rotational position of the rotor relative to the stator based on a pulse signal count value, which is a count value of the pulse signal outputted from the encoder, and sequentially shifts an energizing phase of the electric motor unit to rotate the rotor to a target rotational position that corresponds to the target range of the automatic transmission. When the controller executes the open-loop drive control operation of the electric motor unit, the controller sequentially changes the energizing phase of the electric motor unit regardless of the pulse signal outputted from the encoder and rotates the rotor to the target rotational position based on a phase shifting count value, which is a count value of a number of times of shifting of the energizing phase. When the controller senses an abnormality of the encoder, the controller rotates the rotor through the execution of the open-loop drive control operation in presence of the output of the signal from the shift range selecting device to shift the shift range of the automatic transmission to the target range and sets a range shifting operation prohibiting period, which is a predetermined time period, after the shifting of the shift range of the automatic transmission to the target range to prohibit a new range shifting operation of the automatic transmission throughout the range shifting operation prohibiting period.

### BRIEF DESCRIPTION OF THE DRAWINGS

The drawings described herein are for illustration purposes only and are not intended to limit the scope of the present disclosure in any way.

FIG. 1 is a schematic diagram showing a vehicle control system, which includes a shift-by-wire system according to an embodiment of the present disclosure;

FIG. 2 is a cross-sectional view showing an actuator of the shift-by-wire system of the embodiment;

FIG. 3 is a schematic perspective view showing a range shift mechanism and components therearound in the shift-by-wire system of the embodiment;

FIG. 4A is a schematic diagram showing an operational state of a detent plate of the shift-by-wire system upon placement of the shift range in a P-range;

FIG. 4B is a schematic diagram showing another operational state of the detent plate of the shift-by-wire system upon placement of the shift range in a D-range; and

FIG. 5 is a flowchart showing a flow of an operation that is executed at the shift-by-wire system of the embodiment upon occurrence of an abnormality in an encoder.

### DETAILED DESCRIPTION

An embodiment of the present disclosure will now be described with reference to the accompanying drawings. In the following description, an electronic control unit will be abbreviated as “ECU.”

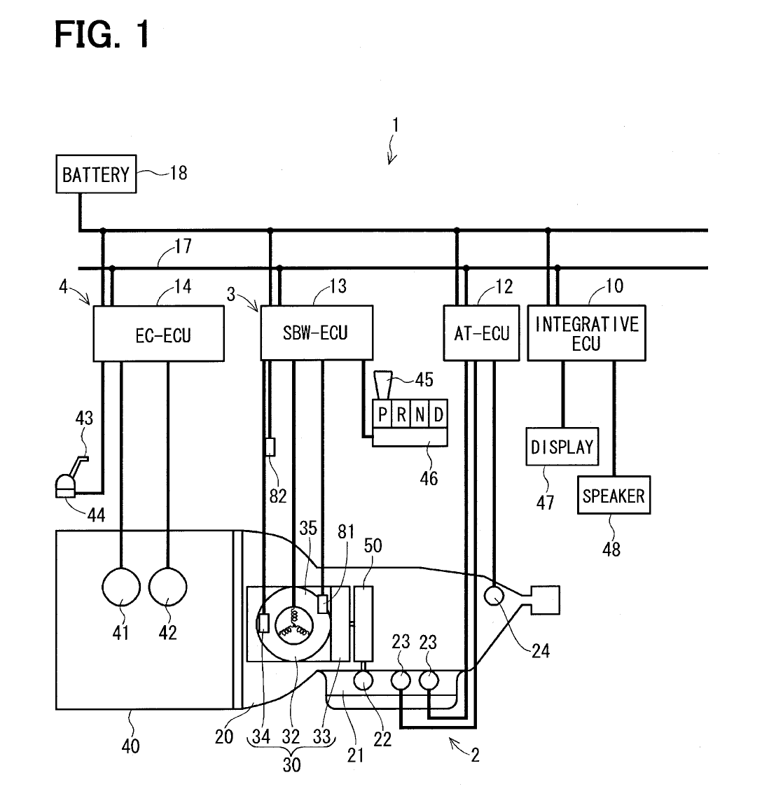

FIG. 1 shows a vehicle control system 1, which is installed in, for example, a four-wheel vehicle (also referred to as a four-wheel automobile). The vehicle control system 1 includes an automatic transmission (AT) control system 2, a shift-by-wire (SBW) system 3, an engine control (EC) system 4 and an integrative ECU 10.

The automatic transmission (AT) control system 2, the shift-by-wire (SBW) system 3 and the engine control (EC) system 4 include an AT-ECU 12, an SBW-ECU 13 and an EC-ECU 14, respectively. Each of the AT-ECU 12, the SBW-ECU 13 and the EC-ECU 14 is constructed as a small computer that includes a central processing unit (CPU), a read-only memory (ROM), a random-access memory (RAM) and an input/output device. The CPU may possibly serve as a computing means. The ROM and the RAM may possibly serve as storage devices or a storage means. The input/output device may possibly serve as an input/output means. The AT-ECU 12, the SBW-ECU 13 and the EC-ECU 14 are electrically or optically interconnected with each other through a local-area network (LAN) line 17 installed in the vehicle. The AT-ECU 12, the SBW-ECU 13, the EC-ECU 14 and the integrative ECU 10 are electrically connected to a battery 18 (an electric power source of the vehicle) and are driven by the electric power supplied from the battery 18. The integrative ECU 10 controls the entire vehicle control system 1 in cooperation with the AT-ECU 12, the SBW-ECU 13 and the EC-ECU 14. In the present embodiment, the SBW-ECU 13 may possibly serve as a control device of the present disclosure.

The automatic transmission control system 2 drives the automatic transmission 20 of the vehicle with the hydraulic pressure (oil pressure). The automatic transmission control system 2 includes a hydraulic circuit 21, which shifts a shift range and a gear position of the automatic transmission 20. In this particular embodiment, the automatic transmission 20 is operable in one of a drive range (D-range), a reverse range (R-range), a parking range (P-range) and a neutral range (N-range). The D-range is a forward drive range for driving the vehicle forward. The R-range is a reverse drive range for driving the vehicle backward. The P-range is a non-drive range and is used for parking the vehicle. The N-range is a non-driving range and is used for placing the automatic transmission in a neutral position. The hydraulic circuit 21 includes a manual valve 22, which is a spool valve that serves as a range selecting mechanism. The manual valve 22 is axially movable to change an operational state of the hydraulic circuit 21. When the manual valve 22 is driven to change the operational state of the hydraulic circuit 21, the automatic transmission 20 is set to the corresponding shift range. The automatic transmission 20 includes a plurality of friction engagement elements, each of which is held in an engaged state or disengaged state depending on the selected shift range. The hydraulic circuit 21 includes a plurality of solenoid valves 23, each of which is provided to hydraulically drive each corresponding one of the friction engagement elements. Thereby, each of the friction engagement elements is engaged or disengaged by the hydraulic pressure supplied from the corresponding solenoid valve 23.

The AT-ECU 12 is electrically connected to the corresponding electric components, such as the solenoid valves 23 of the hydraulic circuit 21. Thereby, the AT-ECU 12 electrically controls an output hydraulic pressure of each of the solenoid valves 23. As a result, the AT-ECU 12 controls the output hydraulic pressure of each of the solenoid valves 23 to engage or disengage each corresponding friction engagement element. Furthermore, in the present embodiment, the AT-ECU 12 is electrically connected to a vehicle speed sensor 24, which senses a traveling speed of the vehicle based on, for example, a rotational speed of an output shaft of the automatic transmission 20. The AT-ECU 12 receives a measurement signal, which is outputted from the vehicle speed sensor 24, to sense the vehicle speed. Then, the AT-ECU 12 controls each corresponding solenoid valve 23 based on the sensed vehicle speed.

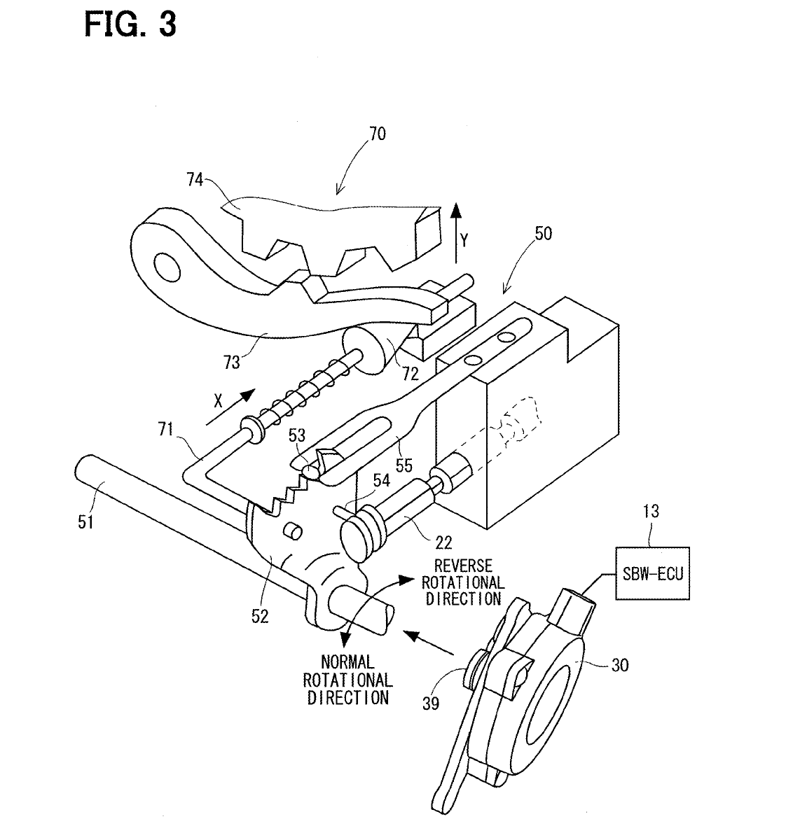

The shift-by-wire system 3 includes the manual valve 22 of the automatic transmission control system 2, an actuator 30 and a range shift mechanism 50. The actuator 30 drives a parking lock mechanism 70 (FIG. 3). The SBW-ECU 13 is one of the components of the shift-by-wire system 3. The actuator 30, which is of an electromagnetic drive type, includes an electric motor unit (hereinafter simply referred to as a motor unit) 32, an encoder 34 and a speed reducing unit 33.

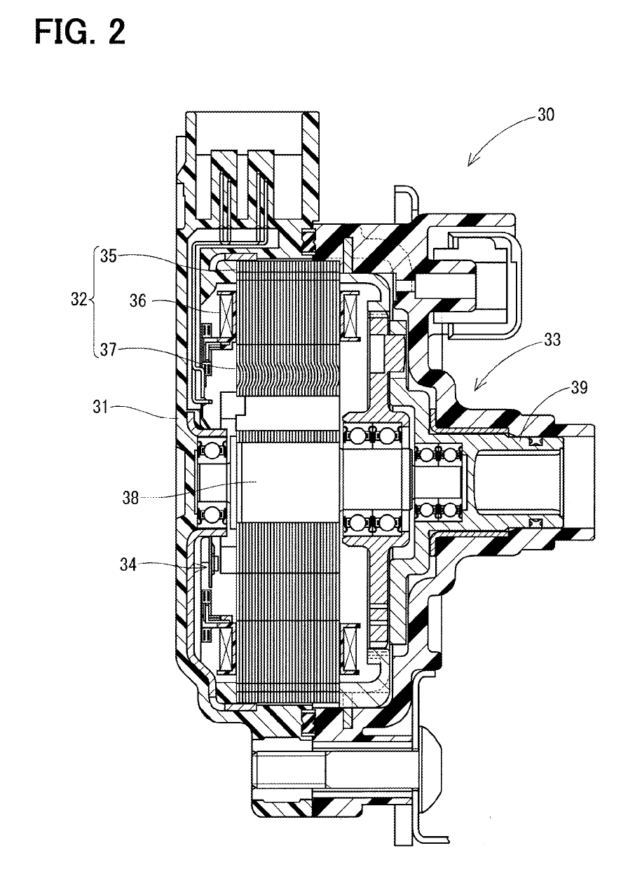

Now, the actuator 30 will be described. In the present embodiment, the motor unit 32 is a switched reluctance (SR) motor, which is a brushless motor that generates a drive force without using permanent magnets. As shown in FIG. 2, the motor unit 32 includes a stator 35, to which a plurality of coils 36 is fitted such that the coils 36 are arranged one after another in a rotational direction (circumferential direction). Furthermore, the motor unit 32 includes a rotor 37, which is placed radially inward of the stator 35. The rotor 37 includes a shaft member 38 that is placed at a center of the rotor 37. The shaft member 38 is rotatably supported by a housing 31 of the actuator 30.

The SBW-ECU 13 sequentially energizes each corresponding one of the coils 36 of the motor unit 32 at predetermined corresponding timing to rotate the rotor 37 and the shaft member 38.

In the present embodiment, the encoder 34 is placed in an inside of the housing 31 of the actuator 30. The encoder 34 includes a permanent magnet and Hall ICs. The permanent magnet is rotated integrally with the rotor 37. The Hall ICs are installed to a circuit board, which is fixed to the housing 31. The Hall ICs are opposed to the permanent magnet and sense a magnetic flux that is generated from the permanent magnet. The encoder 34 outputs a pulse signal in response to a change in a rotational angle of the motor unit 32 (the rotor 37).

The encoder 34 of the present embodiment is an incremental encoder, which outputs a pulse signal in response to rotation of the motor unit 32. The SBW-ECU 13 decrements (counts down) or increments (counts up) the count value in response to the pulse signal, which is outputted from the encoder 34. Thereby, the SBW-ECU 13 can sense the rotational state (e.g., a rotational position and a rotational direction) of the motor unit 32 (the rotor 37). The SBW-ECU 13 can drive, i.e., rotate the motor unit 32 at a high rotational speed without causing desynchronization of the motor unit 32 by sensing the rotational state of the motor unit 32 through the encoder 34. Every time the electric power source of the vehicle is turned on (every time the shift-by-wire system 3 is turned on or every time an ignition key of the vehicle is turned on), an initial drive control operation for executing magnetizing/energizing phase learning of the motor unit 32 (synchronizing of the count value, which corresponds to the pulse signal outputted from the encoder 34, with the energizing phase) is performed. With this initial drive control operation, the rotation of the actuator 30 can be appropriately controlled.

The speed reducing unit 33 reduces the rotational speed of the rotation of the motor unit 32 (the shaft member 38) and outputs the rotation of the reduced rotational speed from the output shaft 39 to the range shift mechanism 50. The range shift mechanism 50 transmits the rotational drive force, which is outputted from the speed reducing unit 33, to the manual valve 22 and the parking lock mechanism 70.

With reference to FIG. 3, the range shift mechanism 50 includes a manual shaft 51, a detent plate 52 and a detent spring 55. The manual shaft 51 is connected to the output shaft 39 of the speed reducing unit 33 of the actuator 30 and is rotated by the rotational drive force of the motor unit 32. The detent plate 52 radially outwardly extends from the manual shaft 51 and is integrated with the manual shaft 51. Thereby, the detent plate 52 is rotated integrally with the manual shaft 51 by the actuator 30. The detent plate 52 has a pin 54, which projects from the detent plate 52 in parallel with the manual shaft 51. The pin 54 is connected to the manual valve 22. Thereby, when the detent plate 52 is rotated together with the manual shaft 51, the manual valve 22 is reciprocated in the axial direction. That is, the range shift mechanism 50 converts the rotational drive force of the actuator 30 into the linear motion and transmits the linear motion to the manual valve 22.

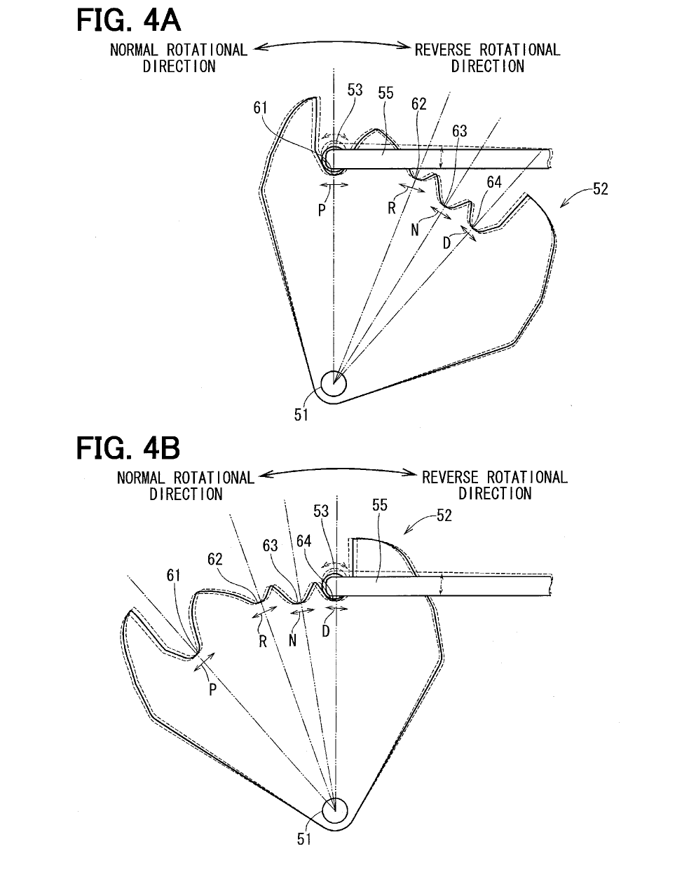

With reference to FIG. 4, the detent plate 52 includes a plurality of recesses 61-64, which are placed one after another along an outer peripheral part of the detent plate 52 that is located radially outward of the manual shaft 51. The recess 61 is formed at one circumferential side of the detent plate 52, which is located at one side in the rotational direction. The recess 64 is formed at the other circumferential side of the detent plate 52, which is located at the other side in the rotational direction, i.e., is opposite from the one circumferential side in the rotational direction. The recess 62 and the recess 63 are located between the recess 61 and the recess 64 in the rotational direction. The recesses 61-64 serve as recesses of the present disclosure.

In the present embodiment, the recess 61 is formed to correspond with the P-range of the automatic transmission. The recess 62 is formed to correspond with the R-range. The recess 63 is formed to correspond with the N-range. The recess 64 is formed to correspond with the D-range.

The detent spring 55 is resiliently deformable and includes a detent roller 53 that is placed at a distal end portion of the detent spring 55 and serves as a limiting portion. The detent spring 55 urges the detent roller 53 toward the center (i.e., toward the manual shaft 51) of the detent plate 52. With reference to FIGS. 4A and 4B, when a predetermined force is applied to the detent plate 52 through the manual shaft 51, the detent roller 53 is moved from one of the recesses 61-64 to an adjacent one of the recesses 61-64 after passing through a projection interposed between the one of the recesses 61-64 and the adjacent one of the recesses 61-64, as shown in FIGS. 4A and 4B. Therefore, when the manual shaft 51 is rotated by the actuator 30, the axial position of the manual valve 22 and the state of the parking lock mechanism 70 are changed. Thereby, the shift range of the automatic transmission 20 is changed, i.e., is shifted. When the detent roller 53 passes each projection formed between the corresponding adjacent two of the recesses 61-64, the detent spring 55 is resiliently deformed. Furthermore, at this time, the detent roller 53 moves from the one of the recesses 61-64 to the adjacent one of the recesses 61-64 through the corresponding projection while the detent roller 53 is rotated about a rotational axis thereof.

When the detent roller 53 is held in one of the recesses 61-64, the rotation of the detent plate 52 is limited. Thereby, the axial position of the manual valve 22 and the operational state of the parking lock mechanism 70 are determined. In this way, the shift range of the automatic transmission 20 is fixed.

In the present embodiment, with reference to FIGS. 4A and 4B, the rotational direction of the speed reducing unit 33 of the actuator 30 at the time of changing the shift range from the P-range side to the D-range side through the R-range and the N-range is defined as a normal rotational direction. In contrast, the rotational direction of the speed reducing unit 33 of the actuator 30 at the time of changing the shift range from the D-range side to the P-range side through the N-range and the R-range is defined as a reverse rotational direction.

FIG. 3 shows the operational state of the parking lock mechanism 70, in which the shift range is the D-range, i.e., the shift range is other than the P-range. In this operational state, a parking gear 74 is not locked by a parking lock pole 73. Therefore, the rotation of the wheels of the vehicle is enabled. From this operational state, when the speed reducing unit 33 of the actuator 30 is rotated in the reverse rotational direction, the rod 71 is urged in a direction of an arrow X in FIG. 3 through the detent plate 52. Thereby, a tapered portion 72, which is formed in a distal end portion of the rod 71, urges the parking lock pole 73 upwardly in a direction of an arrow Y in FIG. 3. Therefore, the parking lock pole 73 is meshed with the parking gear 74, and thereby the parking gear 74 is locked. As a result, the wheels of the vehicle are placed in the state where the rotation of the wheels is disabled, i.e., is limited. At this time, the detent roller 53 of the detent spring 55 is placed in the state where the detent roller 53 is held in the recess 61 (the state where the detent roller 53 is placed in the center of the recess 61 shown in FIG. 4A), and the actual range of the automatic transmission 20 is the P-range.

In the shift-by-wire system 3, the rotation of the detent plate 52 is limited by the detent spring 55, which has the resiliency. Therefore, when the detent plate 52 is rotated by the motor unit 32, the detent plate 52 swings in the rotational direction (the normal rotational direction or the reverse rotational direction) for a while immediately after the shifting of the shift range to the target range. In FIG. 4A, the detent plate 52, the detent spring 55 and the detent roller 53 in the state immediately after the shifting of the shift range to the P-range are indicated by solid lines. Furthermore, the detent plate 52, the detent spring 55 and the detent roller 53 in the state where the detent plate 52 swings, are indicated by dotted lines. In FIG. 4B, the detent plate 52, the detent spring 55 and the detent roller 53 in the state immediately after the shifting of the shift range to the D-range are indicated by solid lines. Furthermore, the detent plate 52, the detent spring 55 and the detent roller 53 in the state where the detent plate 52 swings, are indicated by dotted lines. A length of the swing time period of the detent plate 52 (i.e., a time period from a time point of starting the swing motion of the detent plate 52 to a time point of stopping the swing motion of the detent plate 52 immediately after the shifting of the shift range to the target range) may vary depending on, for example, the component size tolerances of the range shift mechanism 50, the control accuracy of the motor unit 32 and environmental conditions (e.g., environmental temperature condition).

The SBW-ECU 13 is electrically connected to the motor unit 32, the encoder 34, a selector sensor 46 of a range selector (possibly serving as a shift range selecting device or a shift range selecting means) 45, a temperature sensor (possibly serving as a temperature sensing device or a temperature sensing means) 81 and a voltage sensor (possibly serving as a voltage sensing device or a voltage sensing means) 82.

The selector sensor 46 senses a command range, which is a range commanded by a driver (user) of the vehicle through manipulation of the range selector 45. The selector sensor 46 outputs the sensed signal to the SBW-ECU 13.

The SBW-ECU 13 determines a target range based on the signal, which is outputted from the selector sensor 46 and is relevant to the command range. Specifically, in the present embodiment, the target range is determined based on the signal of the selector sensor 46, the signal of the brake and the signal of the vehicle speed sensor 24. Here, the SBW-ECU 13 may possibly function as a target range determining means of the present disclosure. The SBW-ECU 13 controls the rotation of the actuator 30 such that the shift range of the automatic transmission 20 is held to coincide with the target range, which is determined by the SBW-ECU 13 (the target range determining means). In this way, the actual range of the automatic transmission 20 is changed to the intended range that is specified by the driver.

The temperature sensor 81 is provided to the motor unit 32. The temperature sensor 81 senses the temperature of the motor unit 32 and outputs a measurement signal, which indicates the sensed temperature, to the SBW-ECU 13. The voltage sensor 82 is provided to an electric power supply line, which connects between the SBW-ECU 13 and the coils 36 of the motor unit 32. The voltage sensor 82 senses a voltage, which is applied to the coils 36 of the motor unit 32, and outputs a measurement signal, which indicates the sensed voltage, to the SBW-ECU 13.

As discussed above, the encoder 34 of the present embodiment is the incremental encoder. Therefore, the encoder 34 can sense only the relative rotational position of the motor unit 32. Thus, at the time of shifting the shift range to the desired shift range by rotating the actuator 30, it is necessary to learn a reference position, which corresponds to an absolute position of the speed reducing unit 33 of the actuator 30. After completion of the learning of the reference position of the actuator 30, corresponding rotational positions of the actuator 30, which correspond to the shift ranges (the P-range, the R-range, the N-range and the D-range), respectively, are computed based on the learned reference position and each corresponding predetermined rotational amount (a control constant). Then, the actuator 30 is rotated to the corresponding computed rotational position, which corresponds to the desired shift range. In this way, the actual range can be shifted to the desired shift range. In the present embodiment, the SBW-ECU 13 learns the reference position of the actuator 30, which corresponds to an end portion (the P-range or the D-range) of a rotatable range of the detent plate 52.

After the learning of the reference position, the SBW-ECU 13 can indirectly sense the current actual range (the actual range at the current time) through the computation based on the learned reference position, the predetermined rotational amount and a pulse signal count value (a rotational position of the motor unit 32) received from the encoder 34. In the present embodiment, the SBW-ECU 13 displays the information of the sensed actual range on a display device 47, which is placed at a front side of a driver's seat in a passenger compartment of the vehicle, through the integrative ECU 10. In this way, the driver can check the actual current range. In the present embodiment, the corresponding actual range can be sensed based on each corresponding rotational position of the motor unit 32 that is obtained upon placement of the center of the detent roller 53 in the corresponding one of the shift ranges, i.e., the P-range, the R-range, the N-range and the D-range shown in FIGS. 4A and 4B.

As discussed above, normally, the SBW-ECU 13 senses the rotational position of the rotor 37 relative to the stator 35 based on the pulse signal count value received from the encoder 34 and sequentially shifts the energizing phase (current supply phase) of the motor unit 32 among, for example, a U-phase, a V-phase and a W-phase based on the sensed rotational position of the rotor 37. That is, the electric current is sequentially supplied to the coils 36 of each corresponding phase (the U-phase, the V-phase, the W-phase). Thereby, the rotor 37 is driven to the target rotational position, which corresponds to the target range. That is, the SBW-ECU 13 shifts the shift range to the target range by rotating the motor unit 32 while using the feedback of the rotational state of the rotor 37 (the motor unit 32). The control operation of the SBW-ECU 13 discussed above will be hereinafter referred to as a feedback drive control operation. Here, the SBW-ECU 13 may possibly function as a feedback drive control means of the present disclosure.

The EC-ECU 14 is electrically connected to a throttle 41 of an internal combustion engine (hereinafter simply referred to as an engine) 40 of the vehicle, injectors 42 and an accelerator sensor 44 of an accelerator pedal 43. The throttle 41 adjusts a flow quantity of intake air that flows through an intake air passage of the engine 40. Each injector 42 adjusts an injection quantity of fuel, which is injected into the intake air passage or a corresponding one of cylinders of the engine 40. The accelerator sensor 44 senses an operational amount (amount of depression) of the accelerator pedal 43, which is operated by the driver of the vehicle, and the accelerator sensor 44 outputs a measurement signal to the EC-ECU 14, which indicates the sensed operational amount of the accelerator pedal 43. With the above-described construction, when the accelerator pedal 43 is operated by the driver of the vehicle, the EC-ECU 14 electrically controls the throttle 41 and the injectors 42 based on the operation of the accelerator pedal 43. Therefore, the EC-ECU 14 adjusts the rotational speed and the output torque of the engine 40.

In the state where the SBW-ECU 13 is currently performing the feedback drive control operation, when the transmission of the pulse signal from the encoder 34 is temporarily interrupted for some reason, or when a noise, which overlaps the signal transmitted through the signal line of the encoder 34, is erroneously interrupted as the normal pulse signal, or when the rotation of the rotor 37 is desynchronized, the energizing phase and the rotational phase of the rotor 37 cannot be synchronized with each other, and thereby the rotor 37 cannot be rotated in the normal manner. In this way, the rotation of the rotor 37 may possibly be stopped, or the rotational direction of the rotor 37 may possibly be reversed. Therefore, in the present embodiment, the SBW-ECU 13 always monitors the energizing state of the motor unit 32 and the pulse signal from the encoder 34. When the SBW-ECU 13 senses the abnormality about the pulse signal discussed above or the like, the SBW-ECU 13 determines that the encoder 34 is in the abnormal state (sensing the abnormality of the encoder 34). Here, the SBW-ECU 13 may possibly function as an abnormality sensing means of the present disclosure.

As discussed above, the SBW-ECU 13 rotates the motor unit 32 through the feedback control operation to change the shift range of the automatic transmission 20. In contrast, when the SBW-ECU 13 senses the abnormality of the encoder 34, the SBW-ECU 13 rotates the motor unit 32 through an open-loop drive control operation rather than the feedback drive control operation.

The open-loop drive control operation is a control operation, which sequentially shifts the energizing phase of the motor unit 32 regardless of the pulse signal from the encoder 34 and rotates the rotor 37 to the target rotational position based on a phase shifting count value, which indicates the number of times of shifting of the energizing phase. Specifically, when the encoder 34 is in the abnormal state (i.e., when the SBW-ECU 13 senses the abnormality of the encoder 34) due to, for example, the failure of the encoder 34, the SBW-ECU 13 rotates the motor unit 32 through the open-loop drive control operation, so that the shift range of the automatic transmission 20 is shifted to the target range. The ROM of the SBW-ECU 13 stores the relationship between each shifting number count value and a distance (rotational angle) between the corresponding two of the recesses 61-64. The SBW-ECU 13 rotates the rotor 37 to the target rotational position based on this relationship.

Then, according to the present embodiment, in the state where the SBW-ECU 13 senses the abnormality of the encoder 34, when the output of the signal from the selector sensor 46 of the range selector 45 is present, the SBW-ECU 13 rotates the rotor 37 through the open-loop drive control operation. Also, at this time, the SBW-ECU 13 disables, i.e., prohibits a new range shifting operation (i.e., a next new range shifting operation) of the automatic transmission 20 during a period, which is from a time point of starting the rotation of the rotor 37 through the open-loop drive control operation to a time point of completing the shifting of the shift range of the automatic transmission 20 to the target range in the current range shifting operation of the automatic transmission 20. Specifically, for example, the SBW-ECU 13 may not accept (may ignore) the signal from the selector sensor 46 during the period, which is from the time point of starting the rotation of the rotor 37 through the open-loop drive control operation to the time point of completing the shifting of the shift range of the automatic transmission 20 to the target range in the current range shifting operation of the automatic transmission 20. Alternatively, the SBW-ECU 13 may not rotate the rotor 37 of the motor unit 32 even upon the determination of the target range for the next range shifting operation during the period, which is from the time point of starting the rotation of the rotor 37 through the open-loop drive control operation to the time point of completing the shifting of the shift range of the automatic transmission 20 to the target shift range in the current range shifting operation of the automatic transmission 20. Thereby, the rapid reversal of the rotational direction of the motor unit 32, which would be otherwise caused by the presence of the new shifting command for shifting the shift range, will not occur during the rotation of the motor unit 32 through the open-loop drive control operation. As a result, it is possible to limit the positional deviation between the center of the corresponding recess 61-64 and the detent roller 53.

Furthermore, in the present embodiment, the SBW-ECU 13 sets a range shifting operation prohibiting period, which is a predetermined time period, after the completion of the shifting of the shift range of the automatic transmission 20 to the target range upon the rotation of the rotor 37 through the open-loop drive control operation. Then, the SBW-ECU 13 prohibits the new range shifting operation of the automatic transmission 20 during the range shifting operation prohibiting period. Specifically, for example, the SBW-ECU 13 may not accept (may ignore) the signal from the selector sensor 46 during the range shifting operation prohibiting period. Alternatively, the SBW-ECU 13 may not rotate the rotor 37 of the motor unit 32 even upon the determination of the target range during the range shifting operation prohibiting period.

In this embodiment, at the SBW-ECU 13, a length of the range shifting operation prohibiting period is set to be equal to or longer than a maximum time period, which is assumed to be required at most to converge the mechanical swing motion of the detent plate 52 (substantially stop the mechanical swing motion) after the shifting of the shift range of the automatic transmission 20 to the target range. More specifically, the SBW-ECU 13 sets the length of the range shifting operation prohibiting period based on the temperature of the motor unit 32, which is sensed with the temperature sensor 81, and the voltage, which is applied to the coils 36 and is sensed with the voltage sensor 82.

For example, in the case where the temperature of the motor unit 32 is relatively low, the torque, which is outputted from the motor unit 32, is increased. Thereby, the rotation of the detent plate 52 can be easily stopped by the motor unit 32. Thus, the swing time period of the detent plate 52, during which the detent plate 52 swings, is reduced. In contrast, in the case where the temperature of the motor unit 32 is relatively high, the torque, which is outputted from the motor unit 32, is decreased. Thereby, the rotation of the detent plate 52 cannot be easily stopped by the motor unit 32. Thus, the swing time period of the detent plate 52, during which the detent plate 52 swings, is increased.

Also, for example, in the case where the voltage, which is applied to the motor unit 32, is relatively high, the torque, which is outputted from the motor unit 32, is increased. Thereby, the rotation of the detent plate 52 can be easily stopped by the motor unit 32. Thus, the swing time period of the detent plate 52, during which the detent plate 52 swings, is reduced. In contrast, in the case where the voltage, which is applied to the motor unit 32, is relatively low, the torque, which is outputted from the motor unit 32, is reduced. Thereby, the rotation of the detent plate 52 cannot be easily stopped by the motor unit 32. Thus, the swing time period of the detent plate 52, during which the detent plate 52 swings, is increased.

The SBW-ECU 13 reduces the range shifting operation prohibiting period when the temperature of the motor unit 32 is reduced, or when the voltage, which is applied to the motor unit 32, is increased. In contrast, the SBW-ECU 13 increases the range shifting operation prohibiting period when the temperature of the motor unit 32 is increased, or when the voltage, which is applied to the motor unit 32, is reduced. In the present embodiment, the SBW-ECU 13 sets the length of the range shifting operation prohibiting period in the range of, for example, 0.5 seconds to 1.5 seconds.

According to the present embodiment, the new range shifting operation of the automatic transmission 20 is prohibited in the range shifting operation prohibiting period. Therefore, it is possible to limit the starting of the rotation of the motor unit 32, which is caused by the presence of the new shifting command for shifting the shift range, in the state where the detent plate 52 swings. In this way, it is possible to avoid the progressive increase of the positional deviation between the center of the corresponding recess 61-64 and the detent roller 53 caused by repeating of the rotational movement of the motor unit 32 through the open-loop drive control operation within the short time period.

Furthermore, according to the present embodiment, when the signal is outputted from the selector sensor 46 during the period of prohibiting the new range shifting operation of the automatic transmission 20 (the period of driving the motor unit 32 through the open-loop drive control operation and the range shifting operation prohibiting period), the SBW-ECU 13 displays a sentence or a sign (information), which indicates that “the new range shifting operation of the automatic transmission 20 is prohibited”, on, for example, the display device 47. The information of “the new range shifting operation of the automatic transmission 20 is prohibited” is not necessarily this phrase, i.e., the new range shifting operation of the automatic transmission 20 is prohibited”. That is, as long as the information indicates the prohibition of the new range shifting operation, any information can be used. Also, at the same time, the SBW-ECU 13 generates a voice sound or buzzer sound, which indicates the information of that “the new range shifting operation of the automatic transmission 20 is prohibited”, from a speaker 48 connected to the integrative ECU 10. Again, this information provided as the sound can be any information that indicates the prohibition of the new range shifting operation. Here, the SBW-ECU 13, the integrative ECU 10, the display device 47 and the speaker 48 may possibly function as a notifying means of the present disclosure.

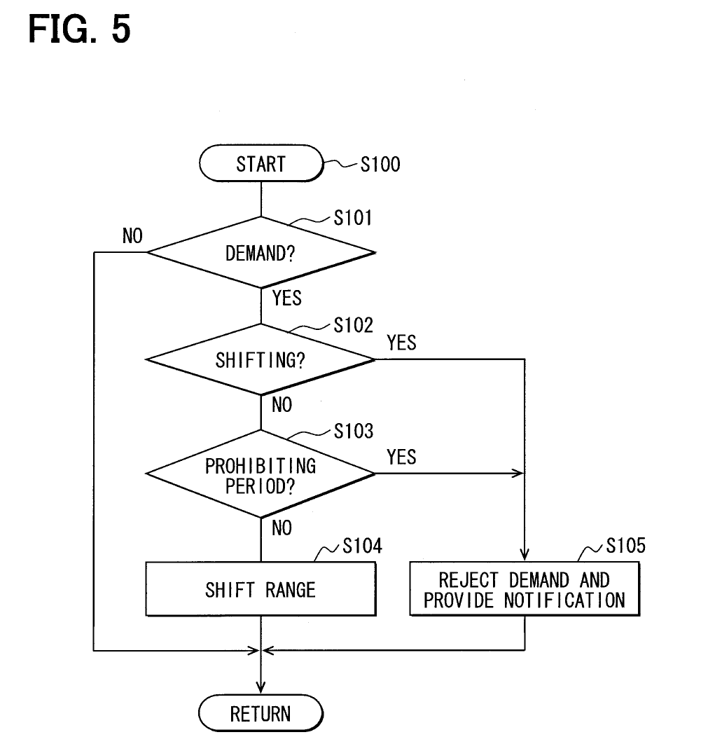

Next, the operation of the SBW-ECU 13 at the time of executing the open-loop drive control operation, i.e., the operation of the SBW-ECU 13 at the time of occurrence of the abnormality of the encoder 34 will be described with reference to FIG. 5. FIG. 5 shows a flow (S100) of the operation of the SBW-ECU 13, which is executed at the time of occurrence of the abnormality of the encoder 34. This flow will be started at step S100 when the abnormality of the encoder 34 is sensed.

At step S101, the SBW-ECU 13 determines whether a new demand of the driver for shifting the shift range is present. Specifically, the SBW-ECU 13 determines whether the demand of the driver for shifting the shift range is present by, for example, determining whether the signal is outputted from the selector sensor 46. When the SBW-ECU 13 determines that the demand of the driver for shifting the shift range is present at step S101 (i.e., YES at step S101), the SBW-ECU 13 proceeds to step S102. In contrast, when the SBW-ECU 13 determines that the demand of the driver for shifting the shift range is not present at step S101 (i.e., NO at step S101), the SBW-ECU 13 repeats step S101. That, the SBW-ECU 13 repeats the flow until the demand of the driver for shifting the shift range is present.

At step S102, the SBW-ECU 13 determines whether it is the middle of the range shifting operation for shifting the shift range of the automatic transmission 20. Specifically, the SBW-ECU 13 determines whether it is the middle of the range shifting operation by, for example, determining whether the motor unit 32 is currently rotating based on the power supply state of the motor unit 32. When the SBW-ECU 13 determines that it is the middle of the range shifting operation at step S102 (i.e., YES at step S102), the SBW-ECU 13 proceeds to step S105. When the SBW-ECU 13 determines that it is not the middle of the range shifting operation at step S102 (i.e., NO at step S102), the SBW-ECU 13 proceeds to step S103.

At step S103, the SBW-ECU 13 determines whether it is in the middle of the range shifting operation prohibiting period. The range shifting operation prohibiting period, which is set after the range shifting operation, is the predetermined length of time that is set after the range shifting operation of step S104 described later. When the SBW-ECU 13 determines that it is the middle of the range shifting operation prohibiting period at step S103 (i.e., YES at step S103), the SBW-ECU 13 proceeds to step S105. When the SBW-ECU 13 determines that it is not the middle of the range shifting operation prohibiting period at step S103 (i.e., NO at step S103), the SBW-ECU 13 proceeds to step S104.

At step S104, the SBW-ECU 13 rotates the motor unit 32 through the open-loop drive control operation to shift the shift range of the automatic transmission 20 to the target range. After step S104, the SBW-ECU 13 returns to step 101 to repeat the flow. When the shift range of the automatic transmission 20 is shifted to the target range (more specifically, when the rotation of the motor unit 32 is stopped upon completion of the shifting of the shift range of the automatic transmission 20 to the target range) at step S104, the SBW-ECU 13 sets the range shifting operation prohibiting period. Here, the SBW-ECU 13 sets the length of the range shifting operation prohibiting period based on the signal received from temperature sensor 81 and the signal received from the voltage sensor 82.

At step S105, when the new demand of the driver for shifting the shift range is present, the SBW-ECU 13 refuses the new demand and notifies the driver that “the new range shifting operation of the automatic transmission 20 is prohibited.” Specifically, when the signal is outputted from the selector sensor 46, the SBW-ECU 13 displays the sentence or the sign, which indicates that “the new range shifting operation of the automatic transmission 20 is prohibited”, on the display device 47. Also, at the same time, the SBW-ECU 13 generates the voice sound or buzzer sound, which indicates that “the new range shifting operation of the automatic transmission 20 is prohibited”, from the speaker 48. After step S105, the SBW-ECU 13 returns to step 101 to repeat the flow.

As discussed above, the flow S100 of FIG. 5 is repeatedly executed when the SBW-ECU 13 rotates the motor unit 32 through the open-loop drive control operation, i.e., when the SBW-ECU 13 senses the abnormality of the encoder 34. That is, at the time of executing the open-loop drive control operation, when the abnormality of the encoder 34 is no longer sensed, the flow S100 of FIG. 5 is terminated, and the motor unit 32 is thereafter rotated through the feedback drive control operation.

As discussed above, according to the present embodiment, in the state where the SBW-ECU 13 senses the abnormality of the encoder 34, when the output of the signal from the selector sensor 46 of the range selector 45 is present, the SBW-ECU 13 rotates the rotor 37 through the open-loop drive control operation (possibly functioning as an open-loop drive control means). Then, when the shift range of the automatic transmission 20 is shifted to the target range through the rotation of the rotor 37, the SBW-ECU 13 sets the range shifting operation prohibiting period, which is the predetermined time period. The SBW-ECU 13 prohibits the new range shifting operation of the automatic transmission 20 throughout the range shifting operation prohibiting period. Therefore, it is possible to limit the starting of the rotation of the motor unit 32, which is caused by the presence of the new shifting command for shifting the shift range, in the state where the detent plate 52 swings. In this way, it is possible to limit the progressive increase of the positional deviation between the corresponding recess 61-64 and the detent roller 53 of the detent spring 55 upon repeating of the rotational operation of the motor unit 32 through the open-loop drive control operation (the open-loop drive control means) within the short period of time. Therefore, according to the present embodiment, even when the abnormality occurs in the encoder 34, it is possible to limit the deviation between the target range and the shift range after the range shifting operation.

Here, it is conceivable that the means for prohibiting the new range shifting operation of the automatic transmission 20 by the SBW-ECU 13 may be a means that does not accept (means that ignores) the signal from the selector sensor 46 during the range shifting operation prohibiting period. Alternatively, the means for prohibiting the new range shifting operation of the automatic transmission 20 by the SBW-ECU 13 may be a means that does not rotate the rotor 37 of the motor unit 32 even upon the determination of the target range during the range shifting operation prohibiting period.

Furthermore, in the present embodiment, the length of the range shifting operation prohibiting period is equal to or longer than the maximum time period, which is assumed to be required at most to converge the mechanical swing motion of the detent plate 52 (substantially stop the mechanical swing motion) after the shifting of the shift range of the automatic transmission 20 to the target range. Therefore, it is possible to reliably avoid the starting of the rotation of the motor unit 32, which is caused by the presence of the new shifting command for shifting the shift range, in the state where the detent plate 52 swings. That is, according to the present embodiment, the new range shifting operation of the automatic transmission 20 is possible in the state where the swing motion of the detent plate 52 is substantially stopped (the state where the detent roller 53 of the detent spring 55 is held in the center of the corresponding recess 61-64) after the completion of the shifting of the shift range to the target range. Thereby, it is possible to limit the occurrence of a fatal mode, at which the shift range is shifted to the unintended range that is different from the target range upon increasing of the positional deviation between the corresponding recess 61-64 and the detent roller 53 of the detent spring 55. Therefore, according to the present embodiment, even when the abnormality occurs in the encoder 34, it is possible to limit the deviation between the target range and the shift range after the range shifting operation.

Furthermore, in the present embodiment, the temperature sensor 81, which can sense the temperature of the motor unit 32, is provided. Furthermore, in the present embodiment, the SBW-ECU 13 sets the length of the range shifting operation prohibiting period based on the temperature, which is sensed with the temperature sensor 81. Upon completion of the shifting of the shift range to the target range, the length of the swing time period of the detent plate 52 varies depending on, for example, the size tolerances of the corresponding components associated with the detent plate 52, the control accuracy of the motor unit 32 and the environmental conditions (e.g., the environmental temperature condition). For example, in the case where the temperature of the motor unit 32 is relatively low, the torque, which is outputted from the motor unit 32, is increased. Thereby, the rotation of the detent plate 52 can be easily stopped by the motor unit 32. Thus, the swing time period of the detent plate 52, during which the detent plate 52 swings, is reduced. In contrast, in the case where the temperature of the motor unit 32 is relatively high, the torque, which is outputted from the motor unit 32, is increased. Thereby, the rotation of the detent plate 52 cannot be easily stopped by the motor unit 32. Thus, the swing time period of the detent plate 52, during which the detent plate 52 swings, is increased. In the present embodiment, the length of the range shifting operation prohibiting period is set based on the temperature of the motor unit 32, which is sensed with the temperature sensor 81. Thereby, it is possible to avoid the setting of the unnecessary long range shifting operation prohibiting period. As a result, the high product value of the shift-by-wire system 3 can be maintained.

Furthermore, in the present embodiment, there is provided the voltage sensor 82, which can sense the voltage applied to the motor unit 32. Furthermore, in the present embodiment, the SBW-ECU 13 sets the length of the range shifting operation prohibiting period based on the voltage, which is sensed with the voltage sensor 82. As discussed above, upon completion of the shifting of the shift range to the target range, the length of the swing time period of the detent plate 52 varies depending on, for example, the size tolerances of the corresponding components associated with the detent plate 52, the control accuracy of the motor unit 32 and the environmental conditions (e.g., the environmental temperature condition). For example, in the case where the voltage applied to the motor unit 32 is relatively high, the torque, which is outputted from the motor unit 32, is increased. Thereby, the rotation of the detent plate 52 can be easily stopped by the motor unit 32. Thus, the swing time period of the detent plate 52, during which the detent plate 52 swings, is reduced. In contrast, in the case where the voltage, which is applied to the motor unit 32, is relatively low, the torque, which is outputted from the motor unit 32, is reduced. Thereby, the rotation of the detent plate 52 cannot be easily stopped by the motor unit 32. Thus, the swing time period of the detent plate 52, during which the detent plate 52 swings, is increased. In the present embodiment, the length of the range shifting operation prohibiting period is set based on the voltage, which is applied to the motor unit 32 and is sensed with the voltage sensor 82. Thereby, it is possible to avoid the setting of the unnecessary long range shifting operation prohibiting period. As a result, the high product value of the shift-by-wire system 3 can be maintained.

Furthermore, according to the present embodiment, in the state where the SBW-ECU 13 senses the abnormality of the encoder 34, when the output of the signal from the selector sensor 46 of the range selector 45 is present, the SBW-ECU 13 rotates the rotor 37 through the open-loop drive control operation (possibly functioning as an open-loop drive control means). Also, at this time, the SBW-ECU 13 prohibits the new range shifting operation of the automatic transmission 20 during the period, which is from the time point of starting the rotation of the rotor 37 through the open-loop drive control operation (open-loop drive control means) to the time point of completing the shifting of the shift range of the automatic transmission 20 to the target shift range. Thereby, the rapid reversal of the rotational direction of the motor unit 32, which would be otherwise caused by the presence of the new shifting command for shifting the shift range, will not occur during the rotation of the motor unit 32 through the open-loop drive control operation (open-loop drive control means). As a result, it is possible to limit the positional deviation between the corresponding recess 61-64 and the detent spring 55.

Furthermore, in the present embodiment, there is provided the means (the display device 47, the speaker 48) that can notify the driver that “the new range shifting operation of the automatic transmission 20 is prohibited” when the signal is outputted from the selector sensor 46 during the period, in which the shifting of the shift range of the automatic transmission 20 is prohibited by the SBW-ECU 13. Thereby, it is possible to let the driver to recognize that “the new range shifting operation of the automatic transmission 20 is prohibited” when the driver manipulates the range selector 45 during the period, in which the shifting of the shift range of the automatic transmission 20 is prohibited by the SBW-ECU 13.

Now, modifications of the above embodiment will be described.

In one modification of the above embodiment, the SBW-ECU 13 and the integrative ECU 10 may display the sentence or the sign, which indicates that “the new range shifting operation of the automatic transmission 20 is prohibited”, on the display device 47 during the period, in which the shifting of the shift range of the automatic transmission 20 is prohibited by the control device (the SBW-ECU 13). Thereby, it is possible to let the driver to recognize that “the new range shifting operation of the automatic transmission 20 is prohibited” during the period, in which the shifting of the shift range of the automatic transmission 20 is prohibited by the SBW-ECU 13. Thereby, it is possible to limit occurrence of confusion of the driver. Here, the SBW-ECU 13, the integrative ECU 10 and the display device 47 may possibly function as a display means of the present disclosure.

Furthermore, in another modification of the above embodiment, the SBW-ECU 13 may not display any particular display on the display device 47 and/or may not generate any particular sound from the speaker even in the presence of the output of the signal from the selector sensor 46 during the period, in which the shifting of the shift range of the automatic transmission 20 is prohibited by the SBW-ECU 13 (the period of driving the motor unit 32 through the open-loop drive control operation and the range shifting operation prohibiting period). That is, the above discussed notifying functions (the notifying means) may be eliminated from the notifying devices, i.e., the display device 47 and the speaker 48 in the above embodiment, if desired.

Furthermore, in another modification of the above embodiment, the SBW-ECU 13 may set the length of the range shifting operation prohibiting period based on one of the signal of the temperature sensor 81 and the signal of the voltage sensor 82. Further alternatively, the SBW-ECU 13 may set the length of the range shifting operation prohibiting period to a predetermined fixed value without using the signal of the temperature sensor 81 and the signal of the voltage sensor 82. In such a case, the temperature sensor 81 (the temperature sensing means) and the voltage sensor 82 (the voltage sensing means) may be eliminated, if desired. Furthermore, in such a case, it is desirable that the length of the range shifting operation prohibiting period is set to be equal to or longer than the maximum time period, which is assumed to be required at most to converge the mechanical swing motion of the detent plate 52 (substantially stop the mechanical swing motion) after the shifting of the shift range of the automatic transmission 20 to the target range.

Furthermore, in the above-described embodiment, in the state where the SBW-ECU 13 senses the abnormality of the encoder 34, when the output of the signal from the selector sensor 46 of the range selector 45 is present, the SBW-ECU 13 rotates the rotor 37 through the open-loop drive control operation. Also, at this time, the SBW-ECU 13 prohibits the new range shifting operation of the automatic transmission 20 during the period, which is from the time point of starting the rotation of the rotor 37 through the open-loop drive control operation to the time point of completing the shifting of the shift range of the automatic transmission 20 to the target shift range. Alternative to this operation, the following operation may be performed. Specifically, in the state where the SBW-ECU 13 senses the abnormality of the encoder 34, when the output of the signal from the selector sensor 46 of the range selector 45 is present, the SBW-ECU 13 rotates the rotor 37 through the open-loop drive control operation. At this time, the SBW-ECU 13 may not prohibit the new range shifting operation of the automatic transmission 20 during the period, which is from the time point of starting the rotation of the rotor 37 to the time point of completing the shifting of the shift range of the automatic transmission 20 to the target shift range in the current range shifting operation of the automatic transmission 20.

Furthermore, the number of recesses of the detent plate is not limited to any particular number and may be changed to any other desired number. That is, the number of the ranges of the automatic transmission, to which the present disclosure is applicable, is not limited to four.

The shift-by-wire system of the present disclosure may be applied to a continuously variable transmission (CVT) or an automatic transmission (A/T) of a hybrid vehicle (HV), which shifts the shift range among four positions, i.e., the P-range, the R-range, the N-range and the D-range. Further alternatively, the shift-by-wire system of the present disclosure may be applied to an electric vehicle (EV), which shifts the shift range between two positions, i.e., the P-range and the not P-range (range other than the P-range). Further alternatively, the shift-by-wire system of the present disclosure may be applied to range shifting of, for example, a parking mechanism of the HV.

In the above embodiment and the modifications thereof, the SBW-ECU 13 alone or in cooperation with the integrative ECU 10 and/or any other electronic control unit(s) installed in the vehicle may possibly serve as a controller of the present disclosure.

As discussed above, the present disclosure is not limited to the above embodiment, and the above embodiment may be modified in various other ways within the spirit and scope of the present disclosure.

What is claimed is:

1. A shift-by-wire system for an automatic transmission of a vehicle, comprising:
an electric motor unit that includes a stator and a rotor, wherein the rotor is rotatable relative to the stator;
a speed reducing unit that includes an output shaft, wherein the speed reducing unit reduces a rotational speed of rotation transmitted from the rotor and outputs the rotation of the reduced rotational speed through the output shaft;
an encoder that outputs a pulse signal in response to the rotation of the rotor;
a detent plate that includes a plurality of recesses and is connected to the output shaft of the speed reducing unit, wherein the detent plate is rotatable by a rotational drive force, which is transmitted from the electric motor unit through the output shaft of the speed reducing unit;
a detent spring that includes a limiting portion, wherein when the limiting portion is fitted into one of the plurality of recesses, the rotation of the detent plate is limited to fix a shift range of the automatic transmission; and
a controller that determines a target range of the automatic transmission among a plurality of ranges based on a signal outputted from a shift range selecting device upon manipulation of the shift range selecting device by a driver of the vehicle and shifts the shift range of the automatic transmission to the target range by rotating the rotor through execution of one of a feedback drive control operation and an open-loop drive control operation of the electric motor unit;
when the controller executes the feedback drive control operation of the electric motor unit, the controller senses a rotational position of the rotor relative to the stator based on a pulse signal count value, which is a count value of the pulse signal outputted from the encoder, and sequentially shifts an energizing phase of the electric motor unit to rotate the rotor to a target rotational position that corresponds to the target range of the automatic transmission;
when the controller executes the open-loop drive control operation of the electric motor unit, the controller sequentially changes the energizing phase of the electric motor unit regardless of the pulse signal outputted from the encoder and rotates the rotor to the target rotational position based on a phase shifting count value, which is a count value of a number of times of shifting of the energizing phase; and
when the controller senses an abnormality of the encoder, the controller rotates the rotor through the execution of the open-loop drive control operation in presence of the output of the signal from the shift range selecting device to shift the shift range of the automatic transmission to the target range and sets a range shifting operation prohibiting period, which is a predetermined time period, after the shifting of the shift range of the automatic transmission to the target range to prohibit a new range shifting operation of the automatic transmission throughout the range shifting operation prohibiting period.

2. The shift-by-wire system according to claim 1, wherein a length of the range shifting operation prohibiting period, which is set by the controller, is equal to or longer than a maximum time period, which is assumed to be required at most to converge mechanical swing motion of the detent plate after shifting of the shift range of the automatic transmission to the target range.

3. The shift-by-wire system according to claim 1, further comprising a temperature sensing device that senses a temperature of the electric motor unit, wherein the controller sets a length of the range shifting operation prohibiting period based on the temperature of the electric motor unit sensed with the temperature sensing device.

4. The shift-by-wire system according to claim 1, further comprising a voltage sensing device that senses a voltage applied to the electric motor unit, wherein the controller sets a length of the range shifting operation prohibiting period based on the voltage sensed with the voltage sensing device.

5. The shift-by-wire system according to claim 1, wherein when the controller senses the abnormality of the encoder, the controller rotates the rotor through the execution of the open-loop drive control operation in presence of the output of the signal from the shift range selecting device and prohibits the new range shifting operation of the automatic transmission throughout a period, which is from a time point of starting the rotation of the rotor to a time point of completing the shifting of the shift range of the automatic transmission to the target shift range in the open-loop drive control operation executed currently.

6. The shift-by-wire system according to claim 1, further comprising a notifying device, wherein the controller operates the notifying device to notify the driver information, which indicates that the new range shifting operation of the automatic transmission is prohibited, when the signal is outputted from the shift range selecting device during a period, in which the new range shifting operation of the automatic transmission is prohibited.

7. The shift-by-wire system according to claim 1, further comprising a display device, wherein the controller operates the display device to display information, which indicates that the new range shifting operation of the automatic transmission is prohibited, when the signal is outputted from the shift range selecting device during a period, in which the new range shifting operation of the automatic transmission is prohibited by the controller.
